(19) United States
(12) Patent Application Publication
(10) Pub. No.: US 2026/0145081 A1
(43) Pub. Date: May 28, 2026

(54) APPARATUS AND METHOD FOR DETERMINING CLIENT TAMPERING

(71) Applicant: NEXON KOREA CORPORATION, Seongnam-si (KR)

(72) Inventor: Lydia WOO, Seongnam-si (KR)

(21) Appl. No.: 19/178,613

(22) Filed: Apr. 14, 2025

(30) Foreign Application Priority Data
Apr. 23, 2024 (KR) 10-2024-0054268

(51) Int. Cl. A63F 13/75

(52) U.S. Cl. CPC A63F 13/75

(57) ABSTRACT

A method of providing a game service to a user includes obtaining user information including information related to a health point (HP) of a character corresponding to the user on the game service. Based on the user information, an operation of reducing the HP of the character by a preset amount is performed. The method further includes detecting whether a change in the information related to the HP of the character has occurred, based on the operation of reducing the HP of the character. Client tampering is then determined based on a result of the detecting. In some embodiments, the HP reduction is dynamically adjusted to avoid disrupting gameplay, and may be triggered periodically or upon receiving a signal to end the game. If tampering is detected, the system may restrict access to the game service. The method may be implemented on a server, user terminal, or game-providing device.

### CROSS-REFERENCE TO RELATED APPLICATION

This application is based on and claims priority under 35 U.S.C. § 119 to Korean Patent Application No. 10-2024-0054268, filed on Apr. 23, 2024, in the Korean Intellectual Property Office, the disclosure of which is incorporated by reference herein in its entirety.

### BACKGROUND

### Technical Field

The disclosure relates to an apparatus and a method for determining client tampering in electronic devices. More particularly, the disclosure relates to an apparatus and a method for determining whether client tampering has been illegally carried out by a user on a game service.

### Description of the Related Art

Many games of various genres have been developed, and with the development of network environments, various services related to games have been provided. As various genres of games are developed and devices for using games are developed, the number of users using games is also increasing.

As the number of game users increases, users who use game services through illegal methods are emerging. As problems arise where general users are harmed by these users, methods to detect and restrict illegal access are provided.

In particular, in single player genres such as casual, RPG, and action, users may use an invincible mode through client tampering, so that a character in a game can continue playing without the game being over even under the set conditions. A method of identifying client tampering on game services at low cost is necessary.

### BRIEF SUMMARY

Provided are an apparatus and a method for determining client tampering based on information related to a health point (HP) of a character corresponding to a user on a game service.

Additional aspects will be set forth in part in the description which follows and, in part, will be apparent from the description, or may be learned by practice of the presented embodiments of the disclosure.

According to an aspect of the disclosure, a method of providing a game service to a user may obtain user information including information related to a HP of a character corresponding to the user on the game service. In an embodiment, in the method, an operation of reducing the HP of the character by the preset amount may be performed based on the user information. In an embodiment, in the method, whether a change in the information related to the HP of the character has occurred may be detected based on the operation of reducing the HP of the character. In an embodiment, in the method, client tampering may be determined based on a result of the detecting.

According to another aspect of the disclosure, a device for providing a game service to a user may include a memory storing at least one instruction and at least one processor configured to execute the at least one instruction stored in the memory. In an embodiment, the at least one processor may be further configured to obtain user information including information related to HP of a character corresponding to the user on the game service. In an embodiment, the at least one processor may be further configured to perform an operation of reducing the HP of the character by a preset amount based on the user information. In an embodiment, the at least one processor may be further configured to detect whether a change in the information related to the HP of the character has occurred, based on the operation of reducing the HP of the character. In an embodiment, the at least one processor may be further configured to determine client tampering based on a result of the detecting.

According to another aspect of the disclosure, a server for providing a game service to a user may include a memory storing at least one instruction and at least one processor configured to execute the at least one instruction stored in the memory. In an embodiment, the at least one processor may be further configured to obtain user information including information related to HP of a character corresponding to the user on the game service. In an embodiment, the at least one processor may be further configured to perform an operation of reducing the HP of the character by a preset amount, based on the user information. In an embodiment, the at least one processor may be further configured to detect whether a change in the information related to the HP of the character has occurred, based on the operation of reducing the HP of the character. In an embodiment, the at least one processor may be further configured to determine client tampering based on a result of the detecting.

According to another aspect of the disclosure, a user terminal for providing a game service to a user may include a memory storing at least one instruction and at least one processor configured to execute the at least one instruction stored in the memory. In an embodiment, the at least one processor may be further configured to obtain user information including information related to HP of a character corresponding to the user on the game service. In an embodiment, the at least one processor may be further configured to perform an operation of reducing the HP of the character by a preset amount, based on the user information. In an embodiment, the at least one processor may be further configured to detect whether a change in the information related to the HP of the character has occurred, based on the operation of reducing the HP of the character. In an embodiment, the at least one processor may be further configured to determine client tampering based on a result of the detecting.

According to another aspect of the disclosure, at least one of the methods of providing a game service may be implemented as a computer program stored on a medium to be executed in conjunction with hardware.

According to another aspect of the disclosure, a computer-readable recording medium having recorded thereon a program that executes at least one of the methods of providing a game service may be provided.

### BRIEF DESCRIPTION OF THE SEVERAL VIEWS OF THE DRAWINGS

The above and other aspects, features, and advantages of certain embodiments of the disclosure will be more apparent from the following description taken in conjunction with the accompanying drawings, in which:

FIG. 1 is a diagram for explaining a system including an electronic device, a server, and a user terminal, according to an embodiment of the present disclosure;

FIG. 2 is a diagram for explaining a method of determining client tampering, according to an embodiment of the present disclosure;

FIG. 3 is a flowchart of a method of determining client tampering, according to an embodiment of the present disclosure;

FIG. 4 is a diagram for explaining a method of determining client tampering based on a signal to end the game service, according to an embodiment of the present disclosure;

FIG. 5 is a diagram for explaining a detailed method of determining client tampering, according to an embodiment of the present disclosure;

FIG. 6 is a diagram for explaining a method of restricting use of a game service when client tampering has occurred, according to an embodiment of the present disclosure;

FIG. 7 is a block diagram for illustrating a configuration of a game providing device, according to an embodiment of the present disclosure;

FIG. 8 is a block diagram for illustrating a configuration of a server, according to an embodiment of the present disclosure; and

FIG. 9 is a block diagram for illustrating a configuration of a user terminal, according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

An embodiment according to the disclosure is described below in detail with reference to the accompanying drawings. Furthermore, a method of configuring and using an electronic device according to an embodiment of the disclosure is described in detail with reference to the accompanying drawings. Like reference numerals or signs presented in each drawing denote like parts or components performing substantially the same function.

Terms including ordinal numbers, such as first, second, etc., may be used to describe various components, but the components are not limited by the terms. Such terms are used only for the purpose of distinguishing one constituent element from another constituent element. For example, without departing from the right scope of the disclosure, a first constituent element may be referred to as a second constituent element, and vice versa. The term “and/or” includes any and all combinations of one or more of the associated listed items.

In the specification, the terminology used herein is for the purpose of describing particular embodiments only and is not intended to limit embodiments. As used herein, the singular forms “a,” “an,” and “the” are intended to include the plural forms as well, unless the context clearly indicates otherwise. In the specification, the terms “comprises” and/or “include” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In the disclosure, when a constituent element “connects” or is “connected” to another constituent element, the constituent element contacts or is connected to the other constituent element not only directly, but also electrically through at least one of other constituent elements interposed therebetween. Furthermore, when a part may “include” a certain constituent element, unless specified otherwise, it may not be construed to exclude another constituent element but may be construed to further include other constituent elements. Furthermore, the terms such as “. . . portion,” “. . . unit,” “. . . module,” and “. . . block” stated in the disclosure may signify a unit to process at least one function or operation and the unit may be embodied by hardware, software, or a combination of hardware and software.

In the disclosure, the term “character” refers to a character on a game service, and may also refer to an object that a user controls within a game service.

In the disclosure, “HP” is an abbreviation for a “hit point” or a “health point” and may refer to the character's stamina in a game. In the following, HP is referred to as health point for the sake of brief description of the specification. When HP is completely depleted, the character may receive a penalty within the game service.

In the disclosure, the term “client tampering” may mean a user manipulating a system within the game service to prevent HP from reducing by intruding into the system without proper access rights. In the following description, the term “client tampering” may be interchangeable with an “invincible mode.”

In the disclosure, a game providing device providing a user interface to a user may mean providing the user interface through a user interface included in the game itself, or through a user's electronic device connected to the game providing device.

In the disclosure, a server controlling a user terminal may mean that the server provides data to be output on the user terminal for communication therebetween (all output devices on the user terminal, such as screen display, sound output, vibration output, lamp light-emitting, etc.) and for the user terminal to perform a preset operation. The user terminal may control the output on the user terminal by using data that is previously stored, but the disclosure is not necessarily limited to the description above.

In the disclosure, transceiving information and data with a user (or a user account) may mean transceiving information and data with a game providing device that corresponds to or is in conjunction with the user (or the user account), but the disclosure is not necessarily limited to the description above.

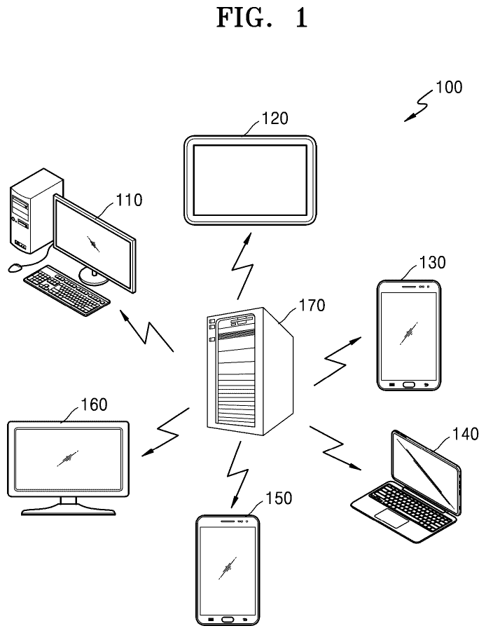

FIG. 1 is a view for explaining a system 100 including a game providing device, a server 170, and user terminals 110 to 160, according to an embodiment of the present disclosure.

Referring to FIG. 1, the system 100 may include the server 170 and at least one of the user terminals 110 to 160. The server 170 may provide various online activities through a network. The server 170 may simultaneously provide online activities to at least one of the user terminals 110 to 160. In an embodiment, the server 170 may provide a game service to a user with respect to various online activities through a network.

According to an embodiment, at least one of the user terminals 110 to 160 may include not only a personal computer (PC) 110, a tablet PC 120, a cellular phone 130, a notebook computer 140, a smart phone 150, and a TV 160, but also various electronic devices such as personal digital assistants (PDA), portable multimedia players (PMP), navigation devices, MP3 players, digital cameras, or the like, but the disclosure is not limited thereto. In an embodiment, at least one of the user terminals 110 to 160 may mean a game providing device.

According to an embodiment, the server 170 may include a single server, a collection of servers, a cloud server, or the like, but the disclosure is not limited thereto. The server 170 may provide various online activities and include a data base storing data for online activities. Furthermore, the server 170 may include a transaction server that creates and processes transaction events. Furthermore, the server 170 may provide a game service to a user. The server 170 may obtain user information on the game service. The user information may include information about HP of a character corresponding to the user. The user information may include information about a client tampering performance history of the user. The information about a client tampering performance history may include information about whether the user has carried out client tampering within the game service, or information about the number of times client tampering was carried out, but the disclosure is not limited thereto. The server 170 may perform an operation of reducing the HP of the character by the preset amount to determine client tampering, and detect whether a change in the information about the HP of the character has occurred. In an embodiment, the server 170 may determine client tampering based on a result of the detecting. When determining that client tampering has occurred, the server 170 may limit use of a game service by a user.

In an embodiment, the server 170 may drive programs to provide a game service. Various embodiments of the disclosure described below may be implemented within programs for providing a game service, or implemented through programs separate from the programs.

According to an embodiment, a network may mean a connection established or formed by using all communication methods, and may mean a communication network connected through all communication methods of transceiving data between terminals or between a terminal and a server.

In an embodiment, all communication methods may include communication methods through a pre-established communication standard, a pre-established frequency band, a pre-established protocol, or a pre-established channel. For example, all communication methods may include a communication method through Bluetooth, Bluetooth low energy (BLE), Wi-Fi, Zigbee, 3G, long-term evolution (LTE), new radio (NR), 6G, ultrasound, or the like, and include all of short-range communication, long-range communication, wireless communication, and wired communication. The communication method is not limited thereto.

According to an embodiment, the short-range communication method may mean a communication method in which communication is established when a device (terminal or server) that performs communication is within a certain range. For example, the short-range communication method may include Bluetooth, NFC, or the like, but the disclosure is not limited thereto.

According to an embodiment, the long-range communication method may mean a communication method in which a device (terminal or server) performs communication regardless of a distance. For example, the long-range communication method may mean a communication method in which two devices perform communication through a repeater such as an AP even when the two devices are separated by a certain distance or more, and may include a communication method using a cellular network (e.g., 3G, LTE, NR, 6G, etc.), such as SMS or telephone, but the disclosure is not limited thereto. In an embodiment, receiving online activities through a network may include that communication between a server and a terminal is established through all communication methods.

According to an embodiment, the online activities may include an online game, a portal service, and a social network service (SNS), but the disclosure is not limited thereto. Furthermore, the online game may include various genres, such as sports, Massively Multiplayer online role-playing game (MMORPG), action online strategy (AOS), first-person shooter (FPS), trading card game (TCG), collectible card game (CCG), or the like. The online game may mean a competitive game between a user and a user or a competitive game between a user and a computer (e.g., artificial intelligence (AI)). The type of the online game is not limited thereto.

According to an embodiment, the game providing device may obtain user information including the information about the HP of the character corresponding to the user on the game service. The user information may include the information about a client tampering performance history of the user. The game providing device may perform an operation of reducing the HP of the character by the preset amount. The game providing device may determine client tampering by detect whether a change in the information about the HP of the character has occurred.

In an embodiment, the game providing device may receive a signal to end the game service from a user. When the user would like to end the game service, the game providing device may provide the user with an interface to input for ending the game service. When the signal to end the game service is received from the user, client tampering may be determined by reducing the HP of the character by the preset amount. In an embodiment, while a user is using the game service, the game providing device may determine, at preset intervals, client tampering by reducing the HP of the character by the preset amount. In an embodiment, the game providing device may set a cycle for performing a character HP reducing operation.

According to an embodiment, the game providing device may determine that no client tampering has occurred when there is a change in the information about the HP of the character according to the character HP reducing operation. In an embodiment, the game providing device may determine that client tampering has occurred when there is a change in the information about the HP of the character according to the character HP reducing operation. When determining that client tampering has occurred, the game providing device may limit use of a game service by a user. In an embodiment, the game providing device may determine a period during which use of a game by a user is limited. In an embodiment, the game providing device may determine an operation of restricting use of the game service by the user, based on the client tampering performance history included in the user information.

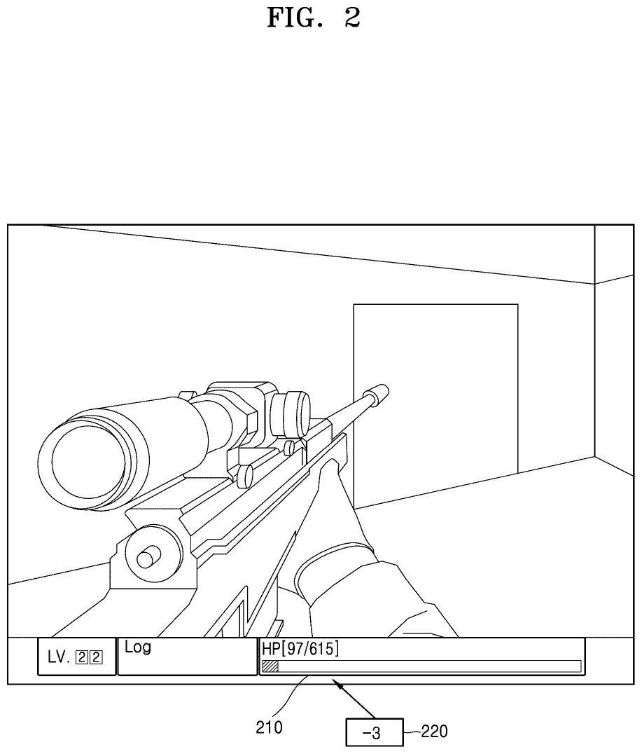

A specific method of providing a game service by the game providing device is described below with reference to FIG. 2 and below.

FIG. 2 is a view for explaining a method of determining client tampering, according to an embodiment of the present disclosure.

Referring to FIG. 2, the game providing device may determine client tampering by a user. In an embodiment, the game providing device may determine whether a user has carried out client tampering, based on the information about the HP of the character corresponding to the user. The client tampering may mean a method of setting, by a user, the HP of a game character not to be reduced in a single play genre, such as action, RPG, casual, FPS, etc., and may be interchangeable with an ‘invincible mode’ in the disclosure.

In an embodiment, the game providing device may obtain user information including information about HP 210 of a character corresponding to the user. The information about HP 210 is information corresponding to the stamina of a character within the game service, and when HP is completely depleted during game play, the character may die or an operation equivalent thereto may be performed. In an embodiment, when the HP of a character is completely depleted, the user may receive a penalty on the game service. For example, when the HP of a character is completely depleted, acquired goods or experience points may be lost.

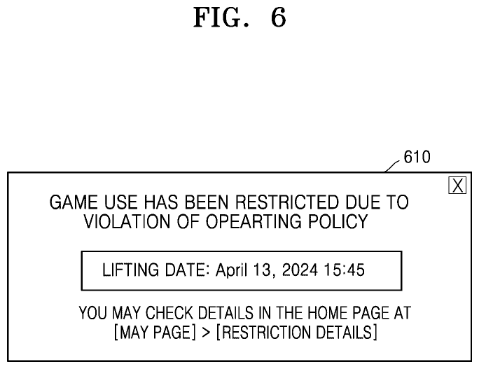

In an embodiment, the user information may include the information about a client tampering performance history of the user, but the disclosure is not limited thereto. The information about a client tampering performance history may mean information about whether a user has carried out client tampering during use of a previous game service, and include information about the number of times a user carried out client tampering. In an embodiment, the information about a client tampering performance history may include information about a user with the same account has carried out client tampering on other games. In an embodiment, the game providing device may determine an operation of restricting use of the game service by the user, based on the information about a client tampering performance history. A specific method of restricting a game service is described below with reference to FIG. 6.

In an embodiment, the game providing device may perform the operation of reducing the HP of the character by the preset amount based on the obtained user information. The game providing device may determine a reduced amount in the HP of a character so as not to disrupt the game operation. When the game providing device reduces positive HP greater than the currently remaining HP of a character, as the HP of the character may be 0, the game providing device may determine an HP reduction amount considering the currently remaining HP amount. For example, when the total HP of a user is 615, and the current HP of a character is 97, the HP of a character of a user may be reduced by 3 (220). In an embodiment, the game providing device may determine the amount of HP to be reduced considering the currently remaining HP amount of a character. For example, when the remaining HP of a user is 3, to ensure that there is no disruption to game operation, the HP may be set to be reduced by an amount less than 1.

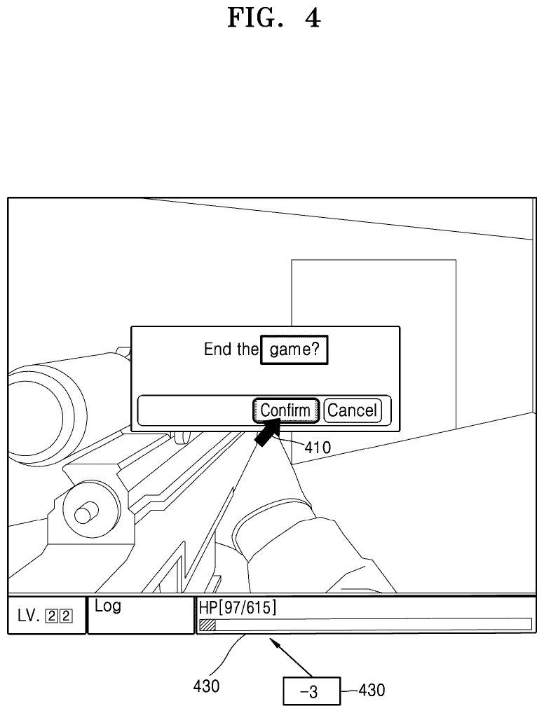

In an embodiment, the game providing device may receive a signal to end the game service from a user. When receiving a signal to end the game service from a user, the game providing device may perform the operation of reducing the HP of the character by the preset amount. In an embodiment, the game providing device may perform, at preset intervals, the operation of reducing the HP of the character by the preset amount. For example, the game providing device may perform the operation of reducing the HP of the character, every two hours, during game play. A specific operation of reducing the HP of the character is described below with reference to FIG. 4.

In an embodiment, the game providing device may recover the HP of a character after determining client tampering, as much as the HP amount reduced to determine client tampering. For example, when determining that the user has not carried out client tampering after reducing the HP of the character by 3, the game providing device may recover the HP of the character by 3.

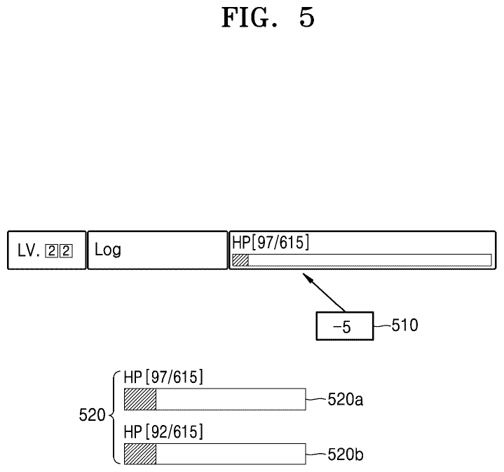

In an embodiment, the game providing device may detect whether a change in the information about the HP of the character has occurred, based on the operation of reducing the HP of the character of reducing the HP of a user. The game providing device may determine client tampering according to a result of the detecting. For example, when there is no change in the HP amount even when the game providing device has reduced the HP of a user by 3, the game providing device may determine that the user has carried out client tampering. When there is a change in the HP amount according to the operation of reducing the HP of a user by the game providing device, the game providing device may determine that the user has not carried out client tampering. A specific example of the method of determining client tampering is described below with reference to FIG. 5.

In an embodiment, the game providing device may when determining that client tampering has occurred, the may limit use of a game service by a user. The game providing device may determine an operation of restricting use of the game service based on the user information. For example, the operation of restricting use of the game service may be determined depending on whether a user has previously carried out client tampering or the number of time client tampering was carried out. A specific game service use restriction is described below with reference to FIG. 6.

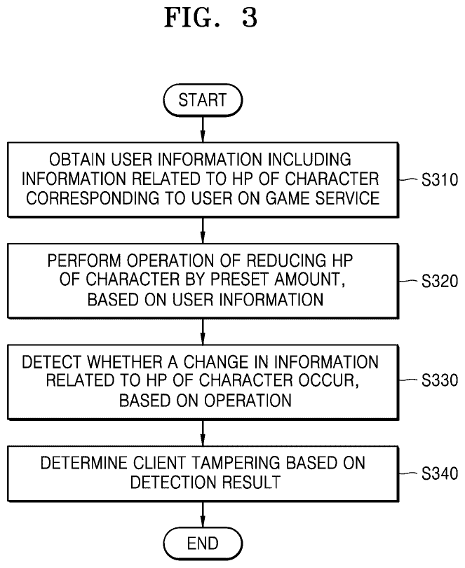

FIG. 3 is a flowchart of a method of determining client tampering, according to an embodiment of the present disclosure.

Referring to FIG. 3, disclosed are operations performed by the game providing device to determine client tampering by a user.

In operation S310, the game providing device may obtain user information including the information about the HP of the character corresponding to the user on the game service. The user information may include all information about a user on the game service.

In an embodiment, the game providing device may obtain all information occurring according to use of the game service by a user. The user information may include information about HP. The information about HP, which is information corresponding to the stamina of a character within the game service, may include information about the total HP amount of a character, the current HP amount of a character, the amount of HP to reduce for determining client tampering, the amount of HP reduced according to damage, or the amount of HP recovered according to items, but the disclosure is not limited thereto. In an embodiment, the user information may include the information about a client tampering performance history of the user. The information about a client tampering performance history may include information about whether a user has carried out client tampering while using the game service, and when a user has carried out client tampering, information about the number of times client tampering was carried out.

In operation S320, the game providing device may perform the operation of reducing the HP of the character by the preset amount, based on the user information. The game providing device may reduce the HP of a character based on the obtained user information, in operation S310.

In an embodiment, the game providing device may determine or change the HP amount of a character to reduce. The game providing device may determine the HP amount of a character to reduce based on the user information. When the current HP amount of a character is small, a small amount not to disrupt the game operation may be reduced. For example, the currently remaining HP of a character is 5, the HP of a character may be set to be reduced by 1 or less to prevent the character from dying. In an embodiment, the game providing device may determine the HP amount to reduce considering the HP amount of a character when an operation for client tampering is being performed.

In an embodiment, when receiving a signal to end the game service from a user, the game providing device may perform the operation of reducing the HP of the character. The game providing device may perform the operation of reducing the HP of the character according to operation S320 to determine whether a user has carried out client tampering, before the game service ends. In an embodiment, the game providing device may perform, at preset intervals, the operation of reducing the HP of the character. The game providing device may set a cycle to check at set intervals whether a user has carried out client tampering. For example, the game providing device may perform, every two hours, the operation of reducing the HP of a user.

In operation S330, the game providing device may detect whether a change in the information about the HP of the character has occurred, based on the operation of reducing the HP of the character of reducing the HP of the character. The game providing device may detect whether a change in the information about the HP of the character has occurred based on operation S320.

In an embodiment, the game providing device may detect whether the HP of a character has reduced by the preset amount. The game providing device may detect whether the HP of a character has reduced by the preset amount, based on the information about the HP of the character included in the user information.

In an embodiment, when the HP of a character is reduced according to the character HP reducing operation, the game providing device may perform an operation of recovering the HP by the reduced amount. When the HP of the character is reduced according to the character HP reducing operation of determining client tampering, the game providing device may recover the HP by the reduced HP for a normal game operation. For example, when an operation to reduce the HP of a character by 3 is performed, and then, it is detected that the HP of a character is reduced by 3 according to the operation, the game providing device may recover the HP of the character by 3.

In operation S340, the game providing device may determine client tampering based on a result of the detecting. The game providing device may determine whether a user has carried out client tampering based on operation S330.

In an embodiment, when it is detected that there is a change in the information about the HP of the character according to the character HP reducing operation, the game providing device may determine that the user has not carried out client tampering. When detecting that there is no change in the information about the HP of the character in spite of the character HP reducing operation, the game providing device may determine that the user has carried out client tampering. When the HP of the character is not reduced in spite of the operation to reduce the HP of a character, the game providing device may determine that the user has carried out client tampering, that is, used the game service in an invincible mode.

In an embodiment, when determining that the user has carried out client tampering, the game providing device may limit use of a game service by a user. The game providing device may limit use of the game service for a user who illegally used the game service through client tampering. For example, the game providing device may restrict the user's access to the game for a certain period of time or restrict access to the game with the identification (ID).

In an embodiment, the game providing device may determine an operation of restricting use of the game service by a user who has carried out client tampering, based on the user information. The user information may include the information about a client tampering performance history of the user. The information about a client tampering performance history may include information about whether the user has carried out client tampering during use of the game service or information about the number of times client tampering was carried out, but the disclosure is not limited thereto.

In an embodiment, the user information may include information about whether the user has carried out client tampering with the same account on other games. For example, even for a user playing a game ‘A’, the game providing device may obtain information about whether the user has carried out client tampering with the same account while playing a game ‘B’. The game providing device may determine the operation of restricting use of game service by the user, based on the information.

When a particular user has carried out client tampering over several occasions, the game providing device may limit use of a game service by a user. For example, for a user who has carried out client tampering once, use of the game service may be restricted for a week, or goods, experience points, or the like acquired through the game service on that day may be initialized. A user who has carried out client tampering twice may receive a stronger restriction. The game providing device may restrict a user who has carried out client tampering more than a preset number to refrain from using the game service. A specific example of the restriction method is described below with reference to FIG. 6.

FIG. 4 is a view for explaining a method of determining client tampering based on a signal to end the game service, according to an embodiment of the present disclosure.

Referring to FIG. 4, the game providing device may receive a signal to end the game service from a user and perform an operation of determining client tampering based on the received signal.

In an embodiment, the game providing device may receive the signal 410 to end the game service from a user. When receiving the signal 410 to end the game service from a user, the game providing device may perform the operation of determining client tampering. When receiving the signal 410 to end the game service, the game providing device may perform the operation of reducing the HP of the character by the preset amount.

In an embodiment, the game providing device may reduce an HP 420 of the character by the preset amount 430 to determine client tampering. In an embodiment, the game providing device may set the HP amount of a character to reduce, in order to determine client tampering. The game providing device may set the HP amount of a character to reduce based on the information about the HP of the character. In an embodiment, the information about HP, which is information corresponding to the stamina of a character within the game service, may include information about the total HP amount of a character, the current HP amount of a character, the amount of HP to reduce for client tampering, the amount of HP reduced according to damage within a game, or the amount of HP recovered according to items, but the disclosure is not limited thereto. For example, when the remaining HP of a character is 4, the HP of a character may be set to be reduced by a small amount (e.g., a value of 1 or less) to prevent the character from dying

In an embodiment, the game providing device may perform, at preset intervals, the operation of reducing the HP of the character to determine client tampering. The game providing device may set a cycle to perform the operation of reducing the HP of the character to periodically check client tampering, in addition to a case of receiving an end signal. For example, the game providing device may perform, every two hours, the operation of reducing the HP of the character. In an embodiment, the game providing device may determine a cycle based on the client tampering performance history information included in the user information. For example, the game providing device may check client tampering by performing the operation of reducing the HP of the character, with more frequent cycles, for a user having a history of carrying out client tampering.

In an embodiment, the game providing device may detect whether a change in the information about HP has occurred according to the character HP reducing operation. The game providing device may determine whether a user has carried out client tampering based on a result of the detecting. In an embodiment, when it is determined that the user has carried out client tampering, the game providing device may limit use of a game service by a user. In an embodiment, the game providing device may determine the operation of restricting use of the game service by the user who has carried out client tampering, based on the client tampering performance history information included in the user information. A specific example of the restriction method is described below with reference to FIG. 6.

In an embodiment, when completely determining that there is a change in the HP of a character according to the operation of reducing the HP of the character, and thus, no client tampering has been carried out, the game providing device may recover the HP of a character by the reduced amount.

FIG. 5 is a view for explaining a detailed method of determining client tampering, according to an embodiment of the present disclosure.

Referring to FIG. 5, the game providing device may obtain user information including the information about the HP of the character. The game providing device may determine client tampering based on the information about the HP of the character.

In an embodiment, the game providing device may perform the operation of reducing the HP of the character by the preset amount 510 to determine client tampering. The game providing device may determine the amount of HP to decrease based on the information about the HP of the character. For example, when the total HP of a character is 615 and the current HP is 97, the game providing device may reduce the HP of a character by 5. The game providing device may determine the HP amount of a character to reduce to prevent the HP of a character from becoming 0. In an embodiment, after determining client tampering, the game providing device may recover the HP of a character by the reduced HP amount.

In an embodiment, the game providing device may determine whether a user has carried out client tampering, based on the operation of reducing the HP of the character. The game providing device may detect whether a change in the information about the HP of the character has occurred, based on the operation of reducing the HP of the character, and determine client tampering based on a result of the detecting. In an embodiment, when there is no change in the information about the HP of the character in spite of the operation of reducing the HP of the character, the game providing device may determine that client tampering has occurred. For example, when the information about the HP of the character is maintained at 97 without a change in spite of an operation of reducing the HP amount of a character by 5 from 97(520a), the game providing device may determine that the user has carried out client tampering.

In an embodiment, the game providing device may not determine that client tampering has occurred when there is a change in the information about the HP of the character according to the operation of reducing the HP of the character. For example, when the HP of a character is reduced to 92 according to the operation of reducing the HP amount of a character by 5 from 97(520b), the game providing device may determine that the user normally used the game service without carrying out client tampering.

In an embodiment, the game providing device may determine client tampering based on the information about the HP of the character and limit use of the game service by the user. The game service restriction is described below with reference to FIG. 6.

In an embodiment, when the HP of a character is reduced according to the character HP reducing operation, the game providing device may perform an operation of recovering the HP of a character by the reduced HP. When the HP of the character is reduced according to the character HP reducing operation to determine client tampering, the game providing device may recover the HP of a character by the reduced HP after determining client tampering.

FIG. 6 is a view for explaining a method of restricting use of a game service when client tampering has occurred, according to an embodiment.

Referring to FIG. 6, when determining that client tampering has carried out, the game providing device may limit use of a game service by a user.

In an embodiment, the game providing device may determine client tampering based on the information about the HP of the character. When determining that the user has carried out client tampering, the game providing device may limit use of the game service by the user. In an embodiment, the game providing device may restrict user's access to the game service for a certain period of time by using a message box 610. For example, when it is determined that a particular user has carried out client tampering as the game service ends on Apr. 6, 2024, at 15:45, the game providing device may restrict the use of the game service by a user for a week. When the user attempts to access again the game service, the game providing device may notify that game use has been restricted due to violation of the operating policy. The game providing device may notify together information (April 13, 2024, 15:45) about the date and time when the game use restriction is lifted.

In an embodiment, the game providing device may notify the reason for restriction of use of the game service by a user. For example, the game providing device may provide information for the user to check the game use restriction reason on My Page.

In an embodiment, the game providing device may initialize goods, experience points, or the like acquired from game use on the date on which the user is determined to have carried out client tampering. For example, information about experience points, items, goods, quest performed, or the like, which are acquired by the user while using a game service in an invincible mode through client tampering may be all initialized.

In an embodiment, the game providing device may determine the operation of restricting use of the game service by the user, based on the user information. The user information may include the information about a client tampering performance history of the user. The information about a client tampering performance history may include information about a history of whether a user has carried out client tampering, information about the number of times a user carried out client tampering, or the like, but the disclosure is not limited thereto.

In an embodiment, the information about a client tampering performance history may include information about a history of whether a user with the same account has carried out client tampering on other games. For example, even for a user playing a game ‘A’, the game providing device may use information about a history of whether the user has carried out client tampering with the same account while playing a game ‘B’.

The game providing device may determine the operation of restricting use of the game service by the user, based on the information about a client tampering performance history. For example, for a user who has carried out client tampering once, the game service may be restricted for a week. The game providing device may implement a stronger restriction for a user who has carried out client tampering multiple times. In an embodiment, the game providing device may use information about whether a user has carried out client tampering on other games in determining the operation of restricting use of the game service by the user.

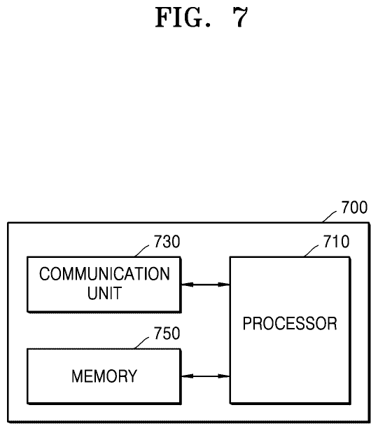

FIG. 7 is a block diagram for illustrating a configuration of a game providing device, according to an embodiment of the present disclosure.

As illustrated in FIG. 7, a game providing device 700 according to an embodiment may include at least one processor 710, a communication unit 730, and a memory 750. However, the components illustrated in FIG. 7 are not all essential components of the game providing device 700. The game providing device 700 may be implemented by more components than the components illustrated in FIG. 7 or by less components than the components illustrated in FIG. 7. The game providing device 700 may be a user terminal, a server, a game network system, or a separate device.

In an embodiment, the at least one processor 710 may typically control the overall operation of the game providing device 700. For example, the at least one processor 710 may generally control the communication unit 730 or the like by executing programs stored in the memory 750. The at least one processor 710 may control the operation of the game providing device 700 in the specification, by controlling the communication unit 730, the memory 750, or the like.

In an embodiment, the at least one processor 710 may obtain user information including the information about the HP of the character corresponding to the user on the game service. The information about the HP of the character, which is information about the stamina of a character within the game service, may include information about the total HP amount of a character, the current HP amount of a character, the amount of HP to reduce for client tampering, the amount of HP reduced according to damage, or the amount of HP recovered according to items, but the disclosure is not limited thereto. The at least one processor 710 may perform the operation of reducing the HP of the character by the preset amount, based on the user information. The at least one processor 710 may set or adjust an HP amount to reduce for the operation of reducing the HP of the character.

In an embodiment, the at least one processor 710 may detect whether a change in the information about the HP of the character has occurred, based on the operation of reducing the HP of the character of reducing the HP of the character. The at least one processor 710 may detect whether a change in the HP of a character has occurred by the set HP amount of a character to reduce, in order to determine client tampering.

In an embodiment, the at least one processor 710 may determine client tampering based on a positive change in the HP of a character. When there is a change in the HP of a character according to the character HP reducing operation, the at least one processor 710 may determine the user to be a normal user who does not carry out client tampering. When there is no change in the HP of a character according to the character HP reducing operation, the at least one processor 710 may determine the user to be a user who has carried out client tampering.

The communication unit 730 may communicate with an external device, under the control of the at least one processor 710. For example, the communication unit 730 may communicate with an external device, such as a transaction server or an authentication server, under the control of the at least one processor 710. Furthermore, the communication unit 730 may obtain various user inputs needed to provide a method according to an embodiment, through communication with an external interface.

In an embodiment, the communication unit 730 may include a Bluetooth communication unit, a BLE communication unit, a near field communication unit, a WLAN (Wi-Fi) communication unit, a Zigbee communication unit, an infrared data association (IrDA) communication unit, a Wi-Fi direct (WFD) communication unit, an ultra-wideband (UWB) communication unit, an Ant+ communication unit, or the like, but the disclosure is not limited thereto.

In an embodiment, the communication unit 730 transceives wireless signals on a mobile communication network with at least one of a base station, an external terminal, or a server. The wireless signal may include various types of data according to transceiving of a voice call signal, a video conference call signal, or a text/multimedia message.

In an embodiment, the communication unit 730 may receive user information including the information about the HP of the character within the game service, under the control of the at least one processor 710. The communication unit 730 may receive a signal to end the game service from a user, under the control of the at least one processor 710.

In an embodiment, the communication unit 730 may transmit information to restrict use of a game service to a user who has carried out client tampering, under the control of the at least one processor 710. The communication unit 730 may provide the user with information about a period during which use of the game service is restricted or the game service being restricted, under the control of the at least one processor 710.

However, the disclosure is not necessarily limited to the example described above, and the game providing device 700 may transmit various pieces of information needed to provide the method according to an embodiment to an external electronic device, or receive the information from the external electronic device.

The memory 750 may store programs for processing and controlling the at least one processor 710, and store data input to the game providing device 700 or output from the game providing device 700.

In an embodiment, the at least one processor 710 may perform a method of providing a game service to a user by using the programs stored in the memory 750.

In an embodiment, the memory 750 may store user information including information about HP. The information about HP, which is information corresponding to the stamina of a character within the game service, may include information about the total HP amount of a character, the current HP amount of a character, the amount of HP to reduce for client tampering, the amount of HP reduced according to damage, or the amount of HP recovered according to items, but the disclosure is not limited thereto. The user information may include the information about a client tampering performance history of the user. The information about a client tampering performance history may include information about a history of whether the user has carried out client tampering or information about the number of times a user carried out client tampering, but the disclosure is not limited thereto. However, the disclosure is not necessarily limited to the example described above, and the memory 750 may include various pieces of information needed for the game providing device 700 to provide the method according to an embodiment.

In an embodiment, the memory 750 may include a storage medium of at least one type among a flash type, a hard disk type, a multimedia card micro type, card type memory (e.g., SD or XD memory, etc.), random access memory (RAM), static random access memory (SRAM), read-only memory (ROM), electrically erasable programmable read-only memory (EEPROM), programmable read-only memory (PROM), magnetic memory, a magnetic disk, or an optical disk. In an embodiment, the programs stored in the memory 750 may be classified into a plurality of modules according to the functions thereof.

In an embodiment, a method of providing a game service may be performed in the game providing device 700 or in a server or a user terminal. Furthermore, at least one configuration included in the game providing device 700 may perform various embodiments described with reference to FIGS. 1 to 6.

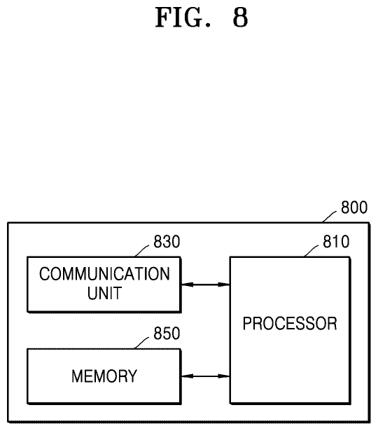

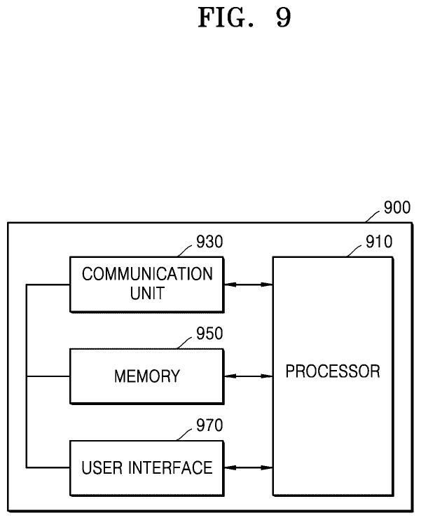

Furthermore, in the method of providing a game service, the game providing device 700, a server, and a user terminal may be performed individually or together. The configurations of a server and a user terminal are described below in detail with reference to FIGS. 8 and 9.

FIG. 8 is a block diagram for illustrating a configuration of a server 800, according to an embodiment of the present disclosure.

As illustrated in FIG. 8, the server 800 according to various embodiments may include at least one processor 810, a communication unit 830, and a memory 850. However, the server 800 may be implemented by more components than the components illustrated in FIG. 8 or less components than the components illustrated in FIG. 8.

In an embodiment, the at least one processor 810 may typically control the overall operation of the server 800. For example, the at least one processor 810 may generally control the communication unit 830, the memory 850, or the like by executing the programs stored in the memory 850. The at least one processor 810 may control the operation of the server 800 in the specification, by controlling the communication unit 830, the memory 850, or the like.

In an embodiment, the at least one processor 810 may obtain user information including the information about the HP of the character corresponding to the user on the game service. The information about the HP of the character, which is information about the stamina of a character within the game service, may include information about the total HP amount of a character, the current HP amount of a character, the amount of HP to reduce for client tampering, the amount of HP reduced according to damage, or the amount of HP recovered according to items, but the disclosure is not limited thereto. The at least one processor 810 may perform the operation of reducing the HP of the character by the preset amount, based on the user information. The at least one processor 810 may set or adjust an HP amount to reduce for the operation of reducing the HP of the character.

In an embodiment, the at least one processor 810 may detect whether a change in the information about the HP of the character has occurred, based on the operation of reducing the HP of the character of reducing the HP of the character. The at least one processor 810 may detect whether a change in the HP of a character has occurred by the set HP amount of a character to reduce, in order to determine client tampering.

In an embodiment, as the detailed operation of the at least one processor 810 may correspond to the operation of the at least one processor 710 of the game providing device 700 described with reference to FIG. 7, redundant descriptions thereof are omitted.

The communication unit 830 may, under the control of the processor 810, receive an input signal to perform game matching from the user terminal 900, and transmit information about a waiting time for performing game matching and matching probability. In an embodiment, the communication unit 830 of the server 800 may transceive data with a user terminal 900, and the data transceived with the user terminal 900 may include control data to control the user terminal 900 or programs included in the user terminal 900.

In an embodiment, the communication unit 830 may include a Bluetooth communication unit, a BLE communication unit, a near field communication unit, a WLAN (Wi-Fi) communication unit, a Zigbee communication unit, an IrDA communication unit, a WFD communication unit, a UWB communication unit, an Ant+ communication unit, or the like, but the disclosure is not limited thereto.

In an embodiment, the communication unit 830 transceives wireless signals on a mobile communication network with at least one of a base station, an external terminal, or a server. The wireless signal may include various types of data according to transceiving of a voice call signal, a video conference call signal, or a text/multimedia message.

The memory 850 may store programs for processing and controlling the processor 810, and store data input to the server 800 or output from the server 800. In an embodiment, the memory 850 may store related information for performing game matching.

In an embodiment, the processor 810 may perform a method of providing a game service to a user by using the programs stored in the memory 850.

In an embodiment, the memory 850 may include a storage medium of at least one type among a flash type, a hard disk type, a multimedia card micro type, card type memory (e.g., SD or XD memory, etc.), RAM, SRAM, ROM, EEPROM, PROM, magnetic memory, a magnetic disk, or an optical disk. In an embodiment, the programs stored in the memory 850 may be classified into a plurality of modules according to the functions thereof.

In an embodiment, as the information stored in the memory 850 may correspond to the information stored in the memory 750 of the game providing device 700, detailed descriptions thereof are omitted.

FIG. 9 is a block diagram for illustrating a configuration of the user terminal 900, according to an embodiment of the present disclosure.

As illustrated in FIG. 9, the user terminal 900 according to various embodiments may include at least one processor 910, a communication unit 930, a memory 950, and a user interface 970. However, the components illustrated in FIG. 9 are not all essential components of the user terminal 900. The user terminal 900 may be implemented by more components than the components illustrated in FIG. 9, or less components than the components illustrated in FIG. 9.

The at least one processor 910 may typically control the overall operation of the user terminal 900. For example, the at least one processor 910 may generally control the communication unit 930, the memory 950, the user interface 970, or the like by executing the programs stored in the memory 950. The at least one processor 910 may control the operation of the user terminal 900 in the specification by controlling the communication unit 930, the memory 950, the user interface 970, or the like.

In an embodiment, the at least one processor 910 may obtain user information including the information about the HP of the character corresponding to the user on the game service. The information about the HP of the character, which is information about the stamina of a character within the game service, may include information about the total HP amount of a character, the current HP amount of a character, the amount of HP to reduce for client tampering, the amount of HP reduced according to damage, or the amount of HP recovered according to items, but the disclosure is not limited thereto. The at least one processor 910 may perform the operation of reducing the HP of the character by the preset amount, based on the user information. The at least one processor 910 may set or adjust an HP amount to reduce for the operation of reducing the HP of the character.

In an embodiment, as the operation of the at least one processor 910 may correspond to the operation of the at least one processor 710 of the game providing device 700 described with reference to FIG. 7, redundant descriptions thereof are omitted.

The communication unit 930 may receive an input signal to end the game service from a user, under the control of the at least one processor 910. The communication unit 930 may receive user information including the information about the HP of the character, under the control of the at least one processor 910. In an embodiment, the communication unit 930 may transceive data with the server 800, and the data transceived with the server 800 may include control data to control the user terminal 900 or programs included in the user terminal 900.

In an embodiment, the communication unit 930 may include a Bluetooth communication unit, a BLE communication unit, a near field communication unit, a WLAN (Wi-Fi) communication unit, a Zigbee communication unit, an IrDA communication unit, a WFD communication unit, a UWB communication unit, an Ant+ communication unit, or the like, but the disclosure is not limited thereto.

In an embodiment, the communication unit 930 transceives wireless signals on a mobile communication network with at least one of a base station, an external terminal, or a server. The wireless signal may include various types of data according to transceiving of a voice call signal, a video conference call signal, or a text/multimedia message.

In an embodiment, as the operation of the communication unit 930 may correspond to the operation of the communication unit 730 of the game providing device 700 described with reference to FIG. 7, detailed descriptions thereof are omitted.

The memory 950 may store programs for processing and controlling the at least one processor 910, and store data to be input to the user terminal 900 or output from the user terminal 900.

In an embodiment, the at least one processor 910 may perform a game providing method by using the programs stored in the memory 950.

In an embodiment, the memory 950 may include a storage medium of at least one type among a flash type, a hard disk type, a multimedia card micro type, card type memory (e.g., SD or XD memory, etc.), RAM, SRAM, ROM, EEPROM, PROM, magnetic memory, a magnetic disk, or an optical disk. Furthermore, according to an embodiment, the programs stored in the memory 950 may be classified into a plurality of modules according to the functions thereof.

In an embodiment, the information stored in the memory 950 may correspond to the information stored in the memory 750 of the game providing device 700, detailed descriptions thereof are omitted.

The user interface 970 may include various interfaces. For example, the user interface 970 may include various interfaces, such as a keypad, a dome switch, a voice input interface, a fingerprint input interface, a touch input interface (a contact electrostatic capacity method, a pressure resistance film method, an infrared detection method, a surface ultrasound conduction method, an integral tension measurement method, a piezo effect method, etc.), a camera, a jog wheel, a jog switch, or the like, and may associate various sensors, such as an acceleration sensor, a position sensor, a temperature sensor, an optical sensor, or the like, with the user interface 970. The disclosure is not limited thereto.

Furthermore, according to an embodiment, the user interface 970 may further include an output unit (not shown). The output unit may include at least one of a liquid crystal display, a thin film transistor-liquid crystal display, an organic light-emitting diode, a flexible display, a three-dimensional (3D) display, or an electrophoretic display. When a display and a touchpad constitute a touch screen by forming a layer structure, the display may be used as an input device other than an output device. Furthermore, the output unit (not shown) may include a light-emitting diode (LED) lamp, a vibration motor, a speaker, a flash, or the like, but the disclosure is not limited thereto.

In an embodiment, the user interface 970 may output information about a game service as an image, a video, sound, or the like.

In an embodiment, the user interface 970 may obtain information from a user by using a keypad or the like. The user interface 970 may output information about a game service use restriction to a user by using the output unit. The user interface 970 may provide an interface for ending the game service to receive an input signal to end the game service from a user.

The devices described above may be implemented by a hardware component, a software component, and/or a combination of a hardware component and a software component. For example, the devices and the components described above in the embodiments may be implemented by using one or more general purpose computers or special purpose computers, such as, a processor, a controller, an arithmetic logic unit (ALU), a digital signal processor, a microcomputer, a field programmable gate array (FPGA), a programmable logic unit (PLU), a microprocessor, or any other devices capable of executing instructions and responding thereto. A processing device may perform an operating system (OS) and one or more software applications performed on the OS. Furthermore, the processing device may access, store, manipulate, process, and generate data in response to the execution of software. For convenience of understanding, one processing device is described as being used, but a person skilled in the art may understand that a processing device may include a plurality of processing elements and/or a multiple types of processing elements. For example, the processing device may include a plurality of processors or one processor and one controller. Furthermore, other processing configurations such as a parallel processor are available.

Software may include a computer program, code, instructions, or a combination of one or more thereof, and may configure the processing devices to operate as desired or may command the processing devices either independently or collectively. To be interpreted by processing devices or to provide commands or data to the processing devices, software and/or data may be permanently or temporarily embodied in any type of machine, components, physical devices, virtual equipment, computer storage medium or devices, or transmitted signal waves. Software may be distributed across networked computer systems and stored or executed in a distribution manner. Software and data may be stored in one or more computer-readable recording media.

The method according to an embodiment may be embodied as program instructions executable by various computer devices, and recorded on a computer-readable medium. The computer-readable medium may include program instructions, data files, data structures, or the like separately or in combinations. The program instructions to be recorded on the medium may be specially designed and configured for the present disclosure or may be well-known to and be usable by those skill in the art of computer software. Examples of the computer-readable recording medium include magnetic media such as hard disks, floppy disks, or magnetic tapes, optical media such as compact disc ROMs (CD-ROMs) or digital video discs (DVDs), magneto-optical media such as floptical disks, and hardware devices such as ROM, RAM, and flash memory, which are specially configured to store and execute program instructions. Examples of the program instructions include not only machine code, such as code made by a compiler, but also high-level language code that is executable by a computer by using an interpreter or the like. The above-described hardware apparatuses may be configured to operate as one or more software modules to perform operations according to various embodiments, or vice versa.

While this disclosure has been particularly shown and described with reference to embodiments thereof, it will be understood by those skilled in the art that various changes in form and details may be made therein without departing from the spirit and scope of the disclosure. For example, appropriate results may be achieved even when the described techniques are performed in a different order than described, and/or components of the described systems, structures, devices, circuits, etc., are coupled or combined in a different manner than described, or are replaced or substituted by other components or equivalents.

Therefore, other implementations, other embodiments, and equivalents to the claims are also included in the scope of the claims described below.

In a method of providing a game service to a user, according to an embodiment, user information including the information related to the HP of the character corresponding to the user on the game service may be obtained. In an embodiment, in the method, the operation of reducing the HP of the character by the preset amount may be performed based on the user information. In an embodiment, in the method, whether a change in the information related to the HP of the character has occurred may be detected based on the operation of reducing the HP of the character. In an embodiment, in the method, client tampering may be determined based on a result of the detecting.

In an embodiment, the user information may include the information related to a client tampering performance history of the user.

In an embodiment, in the method, in case that a signal to end the game service is received, the operation of reducing the HP of the character by the preset amount may be performed.

In an embodiment, in the method, while the user is using the game service, the operation of reducing the HP of the character by the preset amount may be performed at preset intervals.

In an embodiment, in the method, in case that there is no change in the information related to the HP of the character in spite of the operation of reducing the HP of the character by the preset amount, it may be determined that client tampering has occurred. In the method, in case that there is a change in the information related to the HP of the character, it may be determined that client tampering has not occurred.

In an embodiment, in the method, when determining that client tampering has occurred, may limit use of a game service by a user.

In an embodiment, in the method, the operation of restricting use of the game service by the user may be determined based on the user information.

A device for providing a game service to a user according to an embodiment may include a memory storing at least one instruction and at least one processor configured to execute the at least one instruction stored in the memory. In an embodiment, the at least one processor may be further configured to obtain user information including the information related to the HP of the character corresponding to the user on the game service. In an embodiment, the at least one processor may be further configured to perform the operation of reducing the HP of the character by the preset amount, based on the user information. In an embodiment, the at least one processor may be further configured to detect whether a change in the information related to the HP of the character has occurred, based on the operation of reducing the HP of the character of reducing the HP of the character. In an embodiment, the at least one processor may be further configured to determine client tampering based on a result of the detecting.

A server for providing a game service to a user according to an embodiment may include a memory storing at least one instruction and at least one processor configured to execute the at least one instruction stored in the memory. In an embodiment, the at least one processor may be further configured to obtain user information including the information related to the HP of the character corresponding to the user on the game service. In an embodiment, the at least one processor may be further configured to perform the operation of reducing the HP of the character by the preset amount, based on the user information. In an embodiment, the at least one processor may be further configured to detect whether a change in the information related to the HP of the character has occurred, based on the operation of reducing the HP of the character of reducing the HP of the character. In an embodiment, the at least one processor may be further configured to determine client tampering based on a result of the detecting.

A user terminal for providing a game service to a user according to an embodiment may include a memory storing at least one instruction and at least one processor configured to execute the at least one instruction stored in the memory. In an embodiment, the at least one processor may be further configured to obtain user information including the information related to the HP of the character corresponding to the user on the game service. In an embodiment, the at least one processor may be further configured to perform the operation of reducing the HP of the character by the preset amount, based on the user information. In an embodiment, the at least one processor may be further configured to detect whether a change in the information related to the HP of the character has occurred, based on the operation of reducing the HP of the character of reducing the HP of the character. In an embodiment, the at least one processor may be further configured to determine client tampering based on a result of the detecting.

At least one of the methods of providing a game service, according to the embodiments may be implemented as a computer program stored on a medium for execution in conjunction with hardware.

A computer-readable recording medium may be provided which includes a program that executes, on a computer, at least one of the methods of providing a game service, according to an embodiment.

Users may receive game services through an embodiment of the disclosure. Furthermore, according to embodiments of the disclosure, by detecting client tampering based on the HP of a character and restricting use of the game service, it is possible to encourage users to use game services more fairly.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing a game service to a user, the method comprising:
obtaining user information including information related to a health point (HP) of a character corresponding to the user on the game service;
performing an operation of reducing the HP of the character by a preset amount, based on the user information;
detecting whether a change in the information related to the HP of the character has occurred, based on the operation of reducing the HP of the character by the preset amount; and
determining client tampering based on a result of the detecting.

2. The method of claim 1, wherein the user information includes information related to a client tampering performance history of the user.

3. The method of claim 1, wherein the performing of the operation of reducing the HP of the character by the preset amount comprises
performing the operation of reducing the HP of the character by the preset amount in case that a signal to end the game service is received.

4. The method of claim 1, wherein the performing of the operation of reducing the HP of the character by the preset amount comprises
performing the operation of reducing the HP of the character by the preset amount, at preset intervals, while the user is using the game service.

5. The method of claim 1, wherein the determining of the client tampering comprises:
determining that the client tampering has occurred in case that there is no change in the information related to the HP of the character, based on the operation of reducing the HP of the character; and
determining that the client tampering has not occurred in case that there is a change in the information related to the HP of the character, based on the operation of reducing the HP of the character.

6. The method of claim 1, further comprising, in case that the client tampering is determined to have occurred, restricting use of the game service by the user.

7. The method of claim 6, further comprising determining an operation of restricting use of the game service by the user, based on the user information.

8. A device for providing a game service to a user, the device comprising:
a memory storing at least one instruction; and
at least one processor configured to execute the at least one instruction stored in the memory,
wherein the at least one processor is configured to execute the at least one instruction to:
obtain user information including information related to a health point (HP) of a character corresponding to the user on the game service;
perform an operation of reducing the HP of the character by a preset amount, based on the user information;
detect whether a change in the information related to the HP of the character has occurred, based on the operation of reducing the HP of the character; and
determine client tampering based on a result of the detecting.

9. The device of claim 8, wherein the user information includes information related to a client tampering performance history of the user.

10. The device of claim 8, wherein the at least one processor is further configured to, in case that a signal to end the game service is received, perform the operation of reducing the HP of the character by the preset amount.

11. The device of claim 8, wherein the at least one processor is further configured to perform the operation of reducing the HP of the character by the preset amount, at preset intervals, while the user is using the game service.

12. The device of claim 8, wherein the at least one processor is further configured to:
determine that the client tampering has occurred in case that there is no change in the information related to the HP of the character, based on the operation of reducing the HP of the character; and
determine that the client tampering has not occurred in case that there is a change in the information related to the HP of the character, based on the operation of reducing the HP of the character.

13. The device of claim 8, wherein the at least one processor is further configured to, in case that the client tampering is determined to have occurred, restrict use of the game service by the user.

14. The device of claim 13, wherein the at least one processor is further configured to determine an operation of restricting use of the game service by the user, based on the user information.

15. A non-transitory computer-readable recording medium having recorded thereon a program for executing, on a computer, a method of providing a game service to a user, the method comprising:
obtaining user information including information related to a health point (HP) of a character corresponding to the user on the game service;
performing an operation of reducing the HP of the character by a preset amount, based on the user information;
detecting whether a change in the information related to the HP of the character has occurred, based on the operation of reducing the HP of the character; and
determining client tampering based on a result of the detecting.

16. The non-transitory computer-readable recording medium of claim 15, wherein the user information includes information related to a client tampering performance history of the user.

17. The non-transitory computer-readable recording medium of claim 15, wherein the performing of the operation of reducing the HP of the character by the preset amount comprises
performing the operation of reducing the HP of the character by the preset amount in case that a signal to end the game service is received.

18. The non-transitory computer-readable recording medium of claim 15, wherein the performing of the operation of reducing the HP of the character by the preset amount comprises
performing the operation of reducing the HP of the character by the preset amount, at preset intervals, while the user is using the game service.

19. The non-transitory computer-readable recording medium of claim 15, wherein the determining of the client tampering comprises:
determining that the client tampering has occurred in case that there is no change in the information related to the HP of the character, based on the operation of reducing the HP of the character; and
determining that the client tampering has not occurred in case that there is a change in the information related to the HP of the character, based on the operation of reducing the HP of the character.

20. The non-transitory computer-readable recording medium of claim 15, further comprising:
in case that the client tampering is determined to have occurred, restricting use of the game service by the user; and
determining an operation of restricting use of the game service by the user, based on the user information.
